(19) United States
(12) Patent Application Publication
(10) Pub. No.: US 2009/0046469 A1
(43) Pub. Date: Feb. 19, 2009

(54) Light Emitting Diode Module

(75) Inventors: Ching-Fu Yang, Taipei City (TW); Chich-Hua Shen, Taipei City (TW); Lei-Wei Tseng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AMA PRECISION INC., Taipei City (TW)

(21) Appl. No.: 12/191,406

(22) Filed: Aug. 14, 2008

(30) Foreign Application Priority Data
Aug. 16, 2007 (TW) 96130383

(51) Int. Cl. F21V 7/00

(52) U.S. Cl. 362/310

(57) ABSTRACT

A light emitting diode (LED) module is disclosed. The LED module includes a base, a LED component, a pressing piece, and a plurality of screws. The base has a top surface and a positioning hole on the top surface. The LED component has a bottom surface and includes a positioning protrusion on the bottom surface. Wherein after the LED component is disposed on the base, the positioning protrusion is coupled with the positioning hole to position the LED component at the base. A pin of the LED component is located between the pressing piece and the base. The screws are used to screw the pressing member on the base.

### RELATED APPLICATIONS

This application claims priority to Taiwan Application Serial Number 096130383, filed Aug. 16, 2007, which is herein incorporated by reference.

### BACKGROUND OF THE INVENTION

1. Field of the Invention

The invention relates to a light emitting diode (LED) module and, more particularly, to a positioning structure of a LED module.

2. Description of the Related Art

A light emitting diode (LED) is a type of micro solid state light source, has advantages of a small volume, a preferred resistance to shock, electricity-saving, a long life, various colors and so on, and can cooperate with various types of new application requirements, and the LED has been a light source which may be seen everywhere in daily life. Along with the luminous efficiency of the LED becomes higher and higher, the color rendering and the color temperature of the LED become better and better and the price falls, so that the illumination application field of the LED will become broader and broader.

Since the LED may be driven by a low voltage and a low current, it has small power consumption, which saves energy. The LED has a high resistance to shock and may be operated in high frequency, and the waste of the destroyed LED may be recovered to protect the environment. The LED may be flat packaged and may be developed to be a light, slim, short and small product, and based on the above advantages, the LED has good prospects and will be a potential product to replace conventional illuminating apparatus.

### BRIEF SUMMARY OF THE INVENTION

In a preferred embodiment of the invention, a light emitting diode (LED) module is provided to position a LED component on a base.

According to a preferred embodiment of the invention, a LED module is provided. The LED module includes a base, a LED component, a pressing piece and a plurality of screws. The base has a top surface and a positioning hole on the top surface. The LED component has a bottom surface and includes a positioning protrusion on the bottom surface.

When the LED component is disposed on the base, the positioning protrusion is coupled with the positioning hole to position the LED component at the base. One pin of the LED component is located between the pressing piece and the base, and the screws can pass through the base and the pressing piece to lock the pressing piece at the base. The pressing piece may be an elastic member, and the base may be a metal core printed circuit board (MCPCB). In other embodiment, the base may be a heat dissipation base, and the pressing piece is a printed circuit board, and the material of the heat dissipation base is a heat conduction material. Wherein the pressing piece has an opening and one luminous surface of the LED component is exposed from the opening.

The LED module may further include a heat pipe, the base has a passage under the positioning hole, and one end of the heat pipe is disposed in the passage. The LED module can further include an elastic member provided in the passage and used to fix the heat pipe into the passage. The LED module can further include a plurality of heat dissipation fins which are disposed at the other end of the heat pipe and are opposite to the passage.

The LED module can further include a reflector fixed on the base. The LED module can further include a thermal grease coated at the bottom surface of the LED component.

In a LED module of a preferred embodiment of the invention, the positioning protrusion at the bottom surface of the LED component is coupled with the positioning hole of the base to position the LED component on the base. The LED module can make the LED component fixed on the base by the screws and the pressing piece, which restricts the displacement of the LED component in a Z direction. Since the reflector, the pressing piece and the base may be locked by the same group of the screws, affection caused by accumulative tolerance is decreased during the assembly of the LED module. The LED component can directly contact with the base, which makes the heat conductive path shortened to decrease the heat resistance and facilitates the heat dissipation of the LED component.

### BRIEF DESCRIPTION OF THE SEVERAL VIEWS OF THE DRAWINGS

These and other features, aspects, and advantages of the present invention will become better understood with regard to the following description, appended claims, and accompanying drawings.

FIG. 1A is a three-dimensional schematic diagram showing the light emitting diode (LED) module of a preferred embodiment of the invention.

FIG. 1B and FIG. 1C are exploded diagrams showing the LED module in FIG. 1A in different visual angles, respectively.

FIG. 2 is an exploded diagram showing a LED module of another preferred embodiment of the invention.

FIG. 3 is an exploded diagram showing a LED module of another preferred embodiment of the invention.

### DETAILED DESCRIPTION OF THE EMBODIMENTS

The following clearly illustrates the spirit of the invention with accompanying drawings and detailed description, and after understanding embodiments of the invention, persons having ordinary skill in the art may make various modifications and changes without departing from the scope and spirit of the invention according to the technology disclosed by the invention.

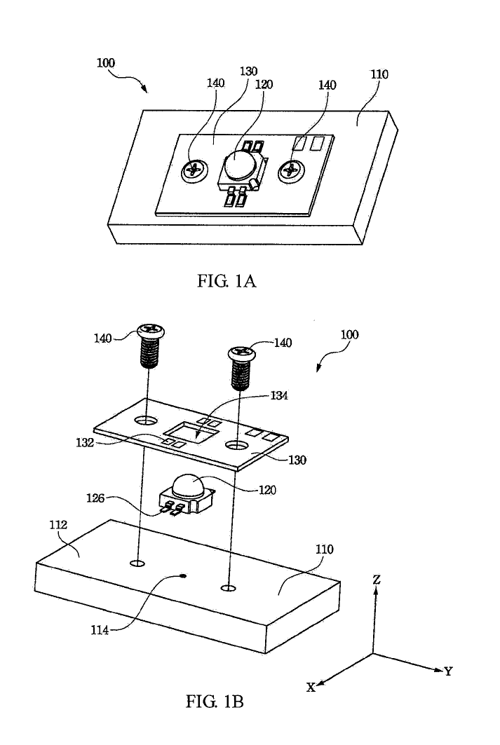

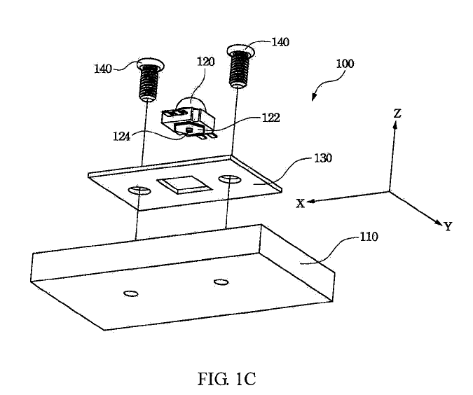

Please refer to FIG. 1A to FIG. 1C. FIG. 1A is a three-dimensional schematic diagram showing the light emitting diode (LED) module of a preferred embodiment of the invention, and FIG. 1B and FIG. 1C are exploded diagrams showing the LED module of the embodiment in different visual angles, respectively. A LED module 100 includes a base 110, a LED component 120, a pressing piece 130 and a plurality of screws 140. The base 110 has a top surface 112 and a positioning hole 114 on the top surface 112. The LED component 120 has a bottom surface 122 and includes a positioning protrusion 124 on the bottom surface 122.

When the LED component 120 is disposed on the base 110, the bottom surface 122 of the LED component 120 contacts with the top surface 112 of the base 110, and the positioning protrusion 124 is coupled with the positioning hole 114 of the base 110 to effectively position the LED component 120 on the base 110 in in X and Y directions. The positioning protrusion 124 and the positioning hole 114 may be circular or polygonal.

The LED component 120 has a pin 126 located between the pressing piece 130 and the base 110. The pin 126 of the LED component 120 contacts with the bottom surface of the pressing piece 130, and the pin 126 is located between the pressing piece 130 and the base 110. At this time, the base 110, the LED component 120 and the pressing piece 130 may be locked by the screws 140 which pass through the base 110 and the pressing piece 130, and thereby the displacement of the LED component 120 in the Z direction is restricted.

In addition, the pressing piece 130 of the embodiment has an opening 134 from which the luminous surface of the LED component 120 is exposed. The bottom surface 122 of the LED component 120 can further be coated with a thermal grease to make the heat generated by the LED component 120 dissipated via the base 110.

In the embodiment, the base 110 is a heat dissipation base, and the pressing piece 130 is a printed circuit board (PCB), and the material of the heat dissipation base is heat conduction material such as metal material, ceramic material or high polymer material, wherein the metal material is copper or aluminum. The bottom surface of the PCB of the pressing piece 130 can have a welding spot 132, and the pin 126 contacts with the welding spot 132. In other embodiment, the base 110 may also be a metal core printed circuit board (MCPCB) and the pressing piece 130 may be an elastic member. The material of the metal part of the MCPCB may be copper or aluminum.

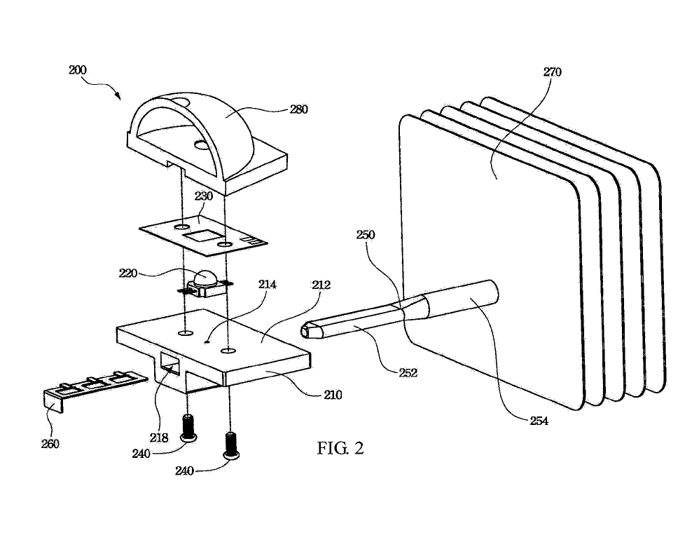

Please refer to FIG. 2 which is an exploded diagram showing a LED module of another preferred embodiment of the invention. A LED module 200 includes a base 210, a LED component 220 disposed on the base 210, and a pressing piece 230 for pressing the LED component 220 on the base 210. In the LED module 200, the base 210 has a passage 218 located under the positioning hole 214 and opposite to the LED component 220. The LED module 200 further includes a heat pipe 250 one end 252 of which is disposed in the passage 218 and an elastic member 260 to fix the heat pipe 250 into the passage 218.

One end 252 of the heat pipe 250 is disposed in the passage 218 of the base 210, and the LED module 200 can include a plurality of heat dissipation fins 270 which are disposed at the other end 254 of the heat pipe 250 and are opposite to the base 210. The heat generated by the LED component 220 is directly conducted to the base 210 and then is conducted to the heat pipe 250 via the base 210, and finally, the heat is dissipated via the heat dissipation fins 270.

The LED module 200 may be applied to a headlight structure. At this time, the LED module 200 can further include a reflector 280, and in the embodiment, the reflector 280, the pressing piece 230 and the base 210 may be locked by the screws 240. Light emitted by the LED component 220 may be adjusted to a wanted light shape via the reflector 280, and then the adjusted light is emitted out of the opening of the reflector 280.

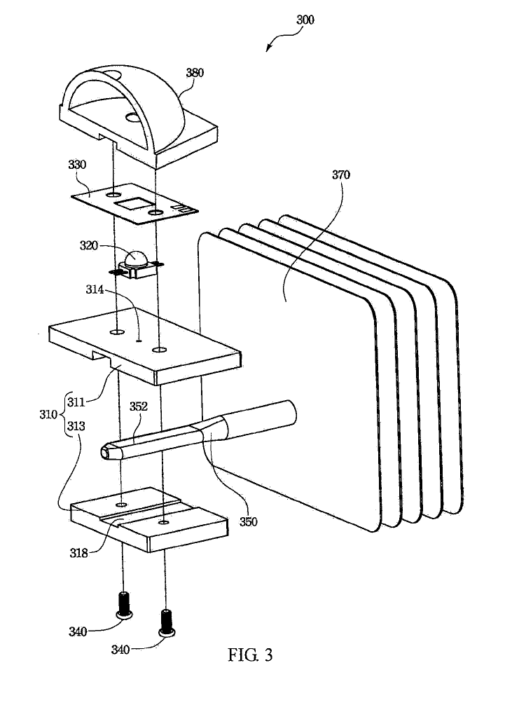

Please refer to FIG. 3 which is an exploded diagram showing a LED module of another preferred embodiment of the invention. A LED module 300 includes a base 310, a LED component 320 disposed on the base 310, and a pressing piece 330 for pressing the LED component 320 on the base 310. In the embodiment, the base 310 can include a top base 311 and a bottom base 313, and a passage 318 is located between the top base 311 and the bottom base 313, and then one end 352 of the heat pipe 350 is provide through the base 310. The passage 318 is preferred to be located under the positioning hole 314. The heat generated by the LED component 320 may be directly transmitted to the base 310 and then is conducted to the heat pipe 350, and finally the heat is dissipated via the heat dissipation fins 370.

The LED module 300 can further include a reflector 380 which can also make the pressing piece 330 locked to the base 310 via the screws 340. Light emitted by the LED component 320 may be adjusted to a wanted light shape via the reflector 380, and then the adjusted light is out of the opening of the reflector 380.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light emitting diode (LED) module comprising:
a base having a top surface and having a positioning hole on the top surface;
a LED component having a bottom surface and including a positioning protrusion on the bottom surface, wherein when the LED component is provided on the base, the positioning protrusion is coupled with the positioning hole to position the LED component at the base;
a pressing piece, wherein one pin of the LED component is located between the pressing piece and the base; and
a plurality of screws passing through the base and the pressing piece to lock the pressing piece at the base.

2. The LED module according to claim 1, wherein the pressing piece is an elastic member.

3. The LED module according to claim 2, wherein the base is a metal core printed circuit board (MCPCB).

4. The LED module according to claim 1, wherein the base is a heat dissipation base.

5. The LED module according to claim 4, wherein the material of the heat dissipation base is heat conduction material.

6. The LED module according to claim 4, wherein the pressing piece is a printed circuit board.

7. The LED module according to claim 1, wherein the pressing piece has an opening, and one luminous surface of the LED component is exposed from the opening.

8. The LED module according to claim 1 further comprising a heat pipe.

9. The LED module according to claim 8, wherein the base further has a passage under the positioning hole, and one end of the heat pipe is disposed in the passage.

10. The LED module according to claim 9, wherein the LED module comprises an elastic member provided in the passage to fix the heat pipe into the passage.

11. The LED module according to claim 9, wherein the LED module further comprises a plurality of heat dissipation fins which are provided at the other end of the heat pipe and are opposite to the passage.

12. The LED module according to claim 1, wherein the LED module further comprises a reflector fixed on the base.

13. The LED module according to claim 1, wherein the LED module further comprises a thermal grease coated at the bottom surface of the LED component.
